(19) United States
(12) Patent Application Publication
(10) Pub. No.: US 2012/0114181 A1
(43) Pub. Date: May 10, 2012

(54) VEHICLE POSE ESTIMATION AND LOAD PROFILING

(76) Inventors: James R. Borthwick, Vancouver (CA); Peter D. Lawrence, Vancouver (CA); Robert A. Hall, Vancouver (CA)

(21) Appl. No.: 13/287,084

(22) Filed: Nov. 1, 2011

Related U.S. Application Data
(60) Provisional application No. 61/408,717, filed on Nov. 1, 2010.

(51) Int. Cl. G06K 9/00

(52) U.S. Cl. 382/104

(57) ABSTRACT

A method of estimating the pose of a vehicle relative to a stereo camera is described herein. The method includes acquiring at least one stereo image of the vehicle from the stereo camera, wherein the stereo image comprises a plurality of scene data points, selecting a plurality of model data points corresponding to a model of the vehicle, wherein the plurality of model data points is representative of at least three degrees of freedom defining the pose of the model relative to the stereo camera, matching each of the plurality of model data points to a closest neighboring one of the plurality of scene data points according to a predetermined coarse-to-fine multi-resolution search approach, and, based on the results of the matching, determining at least three degrees of freedom defining the pose of the vehicle relative to the stereo camera.

### CROSS-REFERENCE TO RELATED APPLICATIONS

This application claims the priority benefit of U.S. provisional application Ser. No. 61/408,717 filed Nov. 1, 2010, which is incorporated herein by reference.

### BACKGROUND OF THE INVENTION

1. Field of Invention

This invention relates to methods and systems for determining the orientation of vehicles, and particularly for determining the orientation of a truck relative to a shovel with which the truck is being loaded.

2. Description of Related Art

Mining shovels are massive machines: a modern shovel (e.g. P&H™4100XPB) has a mass on the order of 1,100 metric tons, and its bucket may contain a payload of over 100 metric tons. When a haul truck ready for loading is parked beside a shovel, the shovel operator must skillfully load the truck in order to avoid injuring the truck driver. Ideally, this is done by depositing the bucket's payload into the centre of the truck bed from a minimal height. However, a momentary miscalculation or lapse of attention on behalf of the shovel operator can cause the shovel to accidently transfer dangerous amounts of kinetic energy to the truck and its driver. For instance, a shovel operator may accidently strike the truck with the bucket, subjecting the truck driver to a violent, unexpected shock and harsh vibrations. Similarly, the operator may, in error, dump the 100 tons of earth onto the rear of the truck bed (its “duck tail”), again creating a dangerous shock and large vibrations. These jolts can immediately injure the truck driver's back, whiplash his/her neck, or both. In addition to immediate injury, truck drivers are also at risk for longer-term problems. The shovel operator may deposit the bucketload in a manner that does not produce a shock severe enough to cause immediate injury, but which does produce vibrations which are dangerous when one is exposed to them repeatedly. The poorer the loading technique, the more severe the vibrations may be, and thus the greater the long-term health risks.

In addition to loading a truck in a safe manner, the shovel operator must also strive to fill the truck with an optimal load. An optimal load can be defined in different ways, but it is always designed so that the haul truck will carry the greatest amount of material without overloading it. At some mines, this optimal load is defined as the total mass that each truck should carry, while at others it is defined in terms of volume. In both cases, the load should be symmetrically distributed from left to right.

While underloading a haul truck results in a drop in mine efficiency, overloading is in fact the greater concern. Overloading a haul truck can cause premature failure of its components (Mechefske and Campbell (2007)) Estimating haul truck duty meters using operational data, In CIM Bulletin, volume 2), greatly increasing maintenance costs. Overloading may also have warranty implications: certain haul truck manufacturers stipulate that trucks overloaded by more than 20% must be immediately unloaded or the truck's warranty may be voided. Uneven left-right load distributions are also a problem as they can effectively overload one side of the truck even if the total mass is within limits. An unevenly loaded haul truck may also damage its body while travelling, because it can cause twisting of the body's frame (frame racking) (Joseph and Welz, M. (2003)). In fact, frame racking can further increase the vibration experienced by the truck's driver. For these reasons, an evenly distributed load is important.

In order to mitigate the accidental positioning of the shovel bucket such that it strikes the truck or deposits its payload in a manner that injures the truck driver, and improve the load quality to reduce damage to the trucks and the cost to maintain them, the precise position and orientation (i.e. pose) of the haul truck relative to the shovel body must be determined.

Stentz et al. (1999) created an autonomous construction-size excavator control system capable of locating and loading a truck. The system found the truck's location by fitting planes to 3D laser scanner data, and from that inferring the six degrees of freedom pose of the truck. However, the system required the excavator to stay stationary for three seconds while the scan data was obtained, which is not practical from a production point of view. Duff (2006) presented a real-time system that was based on a 1/7th scale model of a shovel and haul truck where a 2D laser scanner was used to determine the relative position of the truck based on the minimum enclosing rectangle of its data points, and thereby guide a haul truck into a loading position. The system functioned in real-time, but assumed that the shovel and truck resided on the same plane and hence only determined two translation and one rotation parameters. Although these three degrees of freedom are sufficient for guiding a truck into a loading position, they do not deliver the required accuracy for a loading assistance system.

Green et al. (2007) proposed a system involving vertically mounting a 2D laser scanner to the side of a shovel to acquire multiple scans as the shovel swings, and to combine these scans together into a single scene representation. The system then uses a Bayesian probability method to segment truck data points based on which plane of the truck's structure they reside in. Planes are then fit to each group of data points, and then these best-fit planes are used to derive the position of the truck. The system was demonstrated using only three degrees of freedom, and required approximately 15 seconds worth of data to achieve a reasonable pose estimate, with a translation error of about 0.6 m.

### SUMMARY OF THE INVENTION

According to one aspect of the invention, a method is provided for estimating the pose of a vehicle relative to a stereo camera. The method includes the steps of acquiring at least one stereo image of the vehicle from the stereo camera, wherein the stereo image comprises a plurality of scene data points; selecting a plurality of model data points corresponding to a model of the vehicle, wherein the plurality of model data points is representative of at least three degrees of freedom defining the pose of the model relative to the stereo camera; matching each of the plurality of model data points to a closest neighboring one of the plurality of scene data points according to a predetermined coarse-to-fine multi-resolution search approach; and, based on the results of the matching, determining at least three degrees of freedom defining the pose of the vehicle relative to the stereo camera.

The predetermined coarse-to-fine multi-resolution search approach may further include the steps of: (a) sampling the plurality of scene data points at a first sampling rate to generate a first search layer of sampled scene data points; (b) matching each of the plurality of model points to a closest neighboring one of the sampled scene data points in the first search layer; (c) sampling a subset of the scene data points confined within a defined window around each of the closest neighboring ones of the sampled scene data points identified in step (b) at a second sampling rate; and (d) matching each of the plurality of model points to a closest neighboring one of the sampled subset of scene data points within the defined window. Each of the at least one stereo images may be a 2D projection of a 3D environment in which the vehicle is located, wherein the first sampling rate is determined by the formula:

$$∝ = \frac{r ρ cos ( 45 ° ) cos ( θ x ) cos ( θ y )}{2 d tan ( \frac{F O V}{2} )}$$

wherein a is the sampling rate in the 2D projection space in pixels, r is the linear resolution in pixels of the camera, p is length of the smallest detectable feature in metres in the image, ^{θ}x and ^{θ}y are the maximum angles in degrees of rotation of the patch around the x and y axes relative to the camera, d is the maximum distance in metres between the patch and the camera, and FOV is the angular field of view in degrees of the camera. The second sampling rate may be determined by the same equation as the first sampling rate. The second sampling rate may be lower than the first sampling rate.

According to another aspect of the invention, a system is provided for determining the pose of a vehicle relative to a stereo camera. The system includes a stereo camera for acquiring at least one stereo image of the vehicle, wherein the stereo images comprise a plurality of scene data points. The system further includes a computing system in communication with the at least one stereo camera. The computing system is configured to receive the plurality of scene data points from the at least on stereo camera, select a plurality of model data points corresponding to a model of the vehicle, wherein the plurality of model data points representative of at least three degrees of freedom defining the pose of the model relative to the stereo camera; match each of the plurality of model data points to a closest neighboring one of the scene data points based on a predetermined coarse-to-fine multi-resolution search approach; and, based on the results of the match, determine at least three degrees of freedom defining the pose of the vehicle relative to the stereo camera.

The system may be configured to mount on a boom of a shovel mounted on the vehicle. The computing system may be housed inside a housing of a shovel mounted on the vehicle. To match each of the plurality of model points to the closest neighboring one of the scene data points based on the predetermined coarse-to-fine multi-resolution search approach, the computing system may be configured to: (a) sample the scene data points according to a first sampling rate to generate a first search layer of sampled scene data points; (b) match each of the selected model data points to a closest neighboring one of the sampled scene data points in the first search layer; (c) sample a subset of the scene data points confined within a defined window around each of the closest neighboring one of the sampled scene data points identified in step (b) at a second sampling rate; and (d) match each of the plurality of model points to a closest neighboring one of the sampled subset of scene data points within the defined window. The at least one stereo images may be a 2D projection of a 3D environment in which the vehicle is located, and wherein the first sampling rate is determined by the formula:

$$∝ = \frac{r ρ cos ( 45 ° ) cos ( θ x ) cos ( θ y )}{2 d tan ( \frac{F O V}{2} )}$$

wherein a is the sampling rate in the 2D projection space in pixels, r is the linear resolution in pixels of the camera, p is length of the smallest detectable feature in metres in the image, ^{θ}x and ^{θ}y are the maximum angles in degrees of rotation of the patch around the x and y axes relative to the camera, d is the maximum distance in metres between the patch and the camera, and FOV is the angular field of view in degrees of the camera. The second sampling rate may be determined by the same equation as the first sampling rate. The second sampling rate may be lower than the first sampling rate.

According to another aspect of the invention, a method is provided for profiling a payload in a vehicle bed of a vehicle. The method includes the steps of acquiring at least one stereo image of the vehicle bed containing the payload from a stereo camera located at a fixed position relative to the vehicle bed, wherein the stereo image comprises a plurality of scene data points; selecting a plurality of model points corresponding to a model of the vehicle bed, wherein the plurality of model points is representative of at least three degrees of freedom defining the pose of the model relative to stereo camera; and matching each of the plurality of model data points to a closest neighboring one of the scene data points according to a predetermined coarse-to-fine multi-resolution search approach. Based on the results of the matching, the method further includes: determining the position of the payload surface within the vehicle bed; determining the position of a vehicle bed bottom within the vehicle bed; and calculating the difference between the position of the payload surface and the position of the vehicle bed bottom.

The predetermined coarse-to-fine multi-resolution search approach may include the steps of: (a) sampling the scene data points at a first sampling rate to generate a first search layer of sampled scene data points; (b) matching each of the plurality of model points to a closest neighboring one of the sampled scene data points in the first search layer; (c) sampling a subset of the scene data points confined within a defined window around each of the closest neighboring one of the sampled scene data points identified in step (b) at a second sampling rate; and (d) matching each of the plurality of model points to a closest neighboring one of the sampled subset of scene data points within the defined window. Each of the at least one stereo images may be a 2D projection of a 3D environment in which the vehicle is located, wherein the first sampling rate is determined by the formula:

$$∝ = \frac{r ρ cos ( 45 ° ) cos ( θ x ) cos ( θ y )}{2 d tan ( \frac{F O V}{2} )}$$

wherein a is the sampling rate in the 2D projection space in pixels, r is the linear resolution in pixels of the camera, p is length of the smallest detectable feature in metres in the image, ^{θ}x and ^{θ}y are the maximum angles in degrees of rotation of the patch around the x and y axes relative to the camera, d is the maximum distance in metres between the patch and the camera, and FOV is the angular field of view in degrees of the camera. The second sampling rate may be determined by the same equation as the first sampling rate. The second sampling rate may be lower than the first sampling rate.

A volume of the payload may be calculated based on the calculated difference between the position of the payload surface and the position of the vehicle bed bottom. A mass of the payload may be calculated based on the calculated volume of the payload and the density of the payload. A center of mass of the payload may be calculated based on the calculated difference between the position of the payload surface and the position of the vehicle bed bottom. An ideal center of mass of the payload may be calculated based on the calculated difference between the position of the payload surface and the position of the vehicle bed bottom. Distribution characteristics of the payload may be calculated based on the calculated difference between the position of the payload surface and the position of the vehicle bed bottom. The method of claim 13 may further include displaying a relief map of the payload to the operator based on the calculated difference between the position of the payload surface and the position of the vehicle bed bottom.

According to another aspect of the invention, a system is provided for profiling of a payload in a vehicle bed. The system includes a stereo camera at a fixed position relative to the vehicle bed for acquiring at least one stereo image of the vehicle bed, wherein the stereo images comprise a plurality of scene data points. The system further includes a computing system in communication with the at least one stereo camera, wherein the computing system being configured to: receive the plurality of scene data points from the at least on stereo camera; select a plurality of model data points corresponding to a model of the vehicle bed, wherein the plurality of model data points is representative of at least three degrees of freedom defining the pose of the model relative to the stereo camera; and match each of the plurality of model data points to a closest neighboring one of the scene data points based on a predetermined coarse-to-fine multi-resolution search approach. Based on the results of the matching, the system is further configured to determine the position of the payload surface within the vehicle bed, determine the position of the vehicle bed bottom within the vehicle bed, and calculate the difference between the position of the payload surface and the position of the vehicle bed bottom.

The stereo camera may be configured to mount on a boom of the shovel. The computing system may be housed within a housing of the shovel. To match each of the plurality of model points to the closest neighboring one of the scene data points based on the predetermined coarse-to-fine multi-resolution search approach, the computing system may further be configured to: (a) sample the scene data points according to a first sampling rate to generate a first search layer of sampled scene data points; (b) match each of the selected model data points to a closest neighboring one of the sampled scene data points in the first search layer; (c) sample a subset of the scene data points confined within a defined window around each of the closest neighboring one of the sampled scene data points identified in step (b) at a second sampling rate; and (d) match each of the plurality of model points to a closest neighboring one of the sampled subset of scene data points within the defined window.

The computing system may further be configured to calculate a volume of the payload based on the measured difference between the height of the surface of the payload and the determined location of the bottom of the vehicle bed. The computing system may further be configured to calculate a mass of the payload based on the measured difference between the height of the surface of the payload and the determined location of the bottom of the vehicle bed. The computing system may further be configured to calculate a center of mass of the payload based on the calculated difference between the position of the payload surface and the position of the vehicle bed bottom. The computing system may further be configured to calculate an ideal center of mass of the payload. The computing system may further be configured to calculate distribution characteristics of the payload based on the calculated difference between the position of the payload surface and the position of the vehicle bed bottom.

The system may further include a display device in communication with the computing system, wherein the display device is configured to display a relief map of the payload to the operator based on the calculated difference between the position of the payload surface and the position of the vehicle bed bottom.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In drawings which illustrate embodiments of the invention,

FIG. 1 is a schematic representation of a system for estimating the pose of a haul truck relative to a mining shovel.

FIG. 2 is a block diagram of a method of estimating vehicle pose according to an embodiment of the invention.

FIG. 3 is a block diagram of a method of sampling scene data points according to an embodiment of the invention.

FIG. 4A is a Euclidian distance map showing the distance between a single model point and each scene data point in a scene point cloud.

FIG. 4B is a course-to-fine distance map showing the distance between a single model point and a subset of scene data points in a scene point cloud.

FIG. 5 is a schematic representation of a simplified haul truck body.

FIG. 6A is a stereo image of a haul truck used to create a model point cloud.

FIG. 6B shows the portion of the stereo image in FIG. 6A that is to be used to define a model point cloud.

FIG. 6C shows the model point cloud generated from the portion in FIG. 6B in isolation.

FIG. 7 is a scene point cloud of a haul truck in which the PnP control points used to determine the pose of the haul truck to create a model point cloud.

FIG. 8A is a wireframe representation overlaid on a scene point cloud of an empty haul truck.

FIG. 8B is a wireframe representation overlaid on a scene point cloud of a haul truck that is partially filled with a payload

FIG. 8C is a wireframe representation overlaid on a scene point cloud of a haul truck that is mostly filled with a payload.

FIG. 9A is an image depicting the initial stage of ICP convergence of a model point cloud on a scene point cloud of a haul truck.

FIG. 9B is an image depicting the ICP convergence of a model point cloud on a scene point cloud of a haul truck after one iteration.

FIG. 9C is an image depicting the ICP convergence of a model point cloud on a scene point cloud of a haul truck at convergence.

FIG. 10A is a stereo image of a haul truck before load profiling.

FIG. 10B is a stereo image of a haul truck after load profiling.

FIG. 11 is a graph depicting the uncertainty in stereo camera depth measurement at 1024×768 as a function of distance from a haul truck.

FIG. 12 is a diagram of single slice from a pinhole camera projection.

### DETAILED DESCRIPTION

### Definitions

A “point cloud”, as used herein, refers to a collection of vertices in a three-dimensional coordinate system. These vertices are defined by X, Y, and Z coordinates, and are representative of the external surface of an object.

“Pose”, as used herein, refers to the unique combination of position (i.e. translation) and orientation (i.e. rotation) of a body relative to a given point in space.

### Truck Localization System

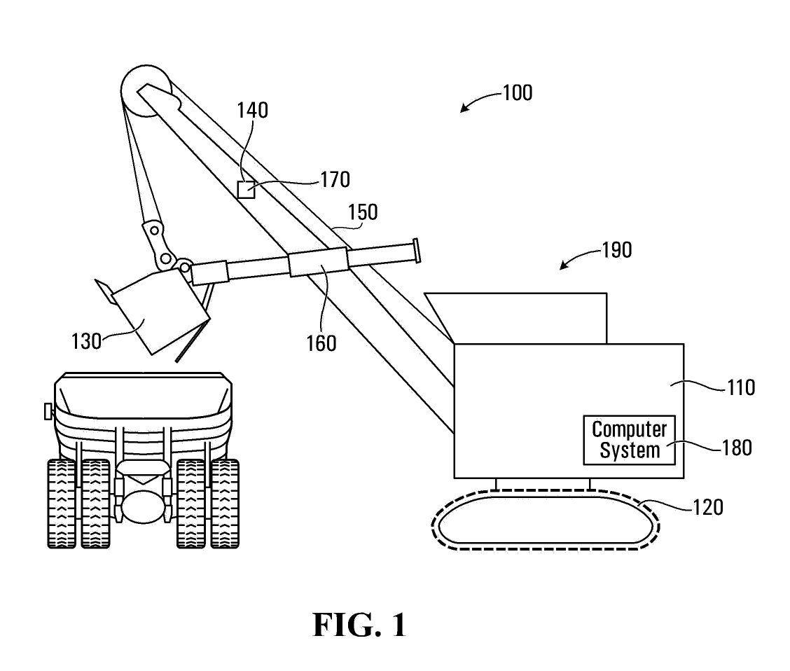

Referring to FIG. 1, a system for determining the pose of a vehicle, a haul truck in this embodiment, relative to a known position, i.e. a stereo camera in this embodiment, is shown generally at 100. System 100 includes at least one sensor, i.e. stereo camera 170, and a computing system 180 in communication with the stereo camera 170. In the present embodiment, the stereo camera 170 is configured to mount on a boom 140 of mining shovel 190 that transfers a payload from the ore deposit to the bed of a haul truck. However, the location to mount the stereo camera 170 is neither limited to the boom 140 of the shovel 190, nor limited to the shovel itself. To give the camera 170 a high perspective of a haul truck that is nearby and to keep the stereo camera sufficiently distant from sources of dust and potential damage from hazards as may be commonly found in a mining operation, it is sufficient that the stereo camera is mounted at an elevated point of known pose relative to the shovel 190. A person skilled in the art will also appreciate that the stereo camera could alternatively be mounted on the truck, or on both the truck and the shovel. Mounting the stereo camera solely on the shovel has the advantages of providing a lower system cost (because the trucks do not have to be modified), a single point of installation, and a single point of maintenance. Moreover, placing the stereo camera on the shovel offers load profiling on a per-bucket basis, with live feedback, which allows the shovel operator to make corrections as the truck is filled.

A person skilled in the art will further appreciate that sensors other than a stereo camera could be used, including monocular cameras (alone or in combination with a grid of laser light), millimeter-wave radar, or time-of flight based laser scanners. Compared to other inherently 3D sources (e.g. radar and laser scanners), stereo cameras offer several advantages including speed (the time to acquire the raw data is constrained only by the shutter speed of the camera system), parallelism (all data points are acquired simultaneously and not via a point-by-point procedure, ensuring all data points represent the same moment in time), data density (by using megapixel cameras, a stereo image can contain more than a million data points, whereas laser scanners and millimeter wave radar systems are to date incapable of delivering the same resolution), cost (digital cameras are ubiquitous and inexpensive), and reliability (cameras with no moving parts can be employed, which decreases susceptibility to damage from shock and vibration).

To protect from the environment and adapt for outdoor industrial use, the camera 170 may be enclosed with a waterproof, shock dampened, heated enclosure. Similarly, to decrease susceptibility to damage from shock and vibration, the computing system 180 may be housed inside a housing 110 of the shovel 190.

Functionally, stereo camera 170 is configured to acquire stereo images of a nearby scene, including the haul truck, from which the data is processed by computing system 180 to determine parameters corresponding to at least three degrees of freedom of the haul truck's pose with respect to the shovel 190. In a preferred embodiment, parameters corresponding to all six degrees of freedom (i.e. three translations, three rotation) relative position of the haul truck are determined.

The data produced by stereo camera 170 is sometimes referred to in the art as 2.5D, because it represents real word 3D data (in x, y, z co-ordinates) projected onto a two dimensional plane (the image sensor in the stereo camera) with pixel positions (i, j) from a single perspective. The data generated by stereo camera 170 can therefore be easily converted into a collection of 3D (x, y, z) data points, collectively called a scene point cloud comprised of a plurality of scene data points. Hereinafter the stereo images produced by camera 170 are said to be represented by a plurality of scene data points, which are used by computing system 180 to determine the pose of the haul truck relative to the camera.

The determination of the haul truck pose relative to the stereo camera 170 is accomplished by registering a second point cloud, i.e. a model point cloud representing a model of the haul truck, directly with the scene point cloud generated by the stereo camera. Since the dimensions and original orientation (i.e rotation) of the model point cloud are precisely known, once the model point cloud is aligned or registered the scene point cloud, it can be inferred that the model haul truck pose is the same as the scene's haul truck pose.

The registration of the scene point cloud and the model point cloud is accomplished by computing system 180. Computing system 180 is configured to define a number of model data points that are representative of parameters corresponding to at least three degrees of freedom of the model haul truck relative to the location of stereo camera 170, thereby forming the model point cloud. Computing system 180 is also configured to match each model data point in the model point cloud to its closest neighboring scene data point based on a predetermined coarse-to-fine multi-resolution search approach, described in detail below. Based on the matching of the model data points to their closest neighboring scene data points, computing system 180 is further configured to determine parameters correspond to at least three degrees of freedom of the haul truck pose relative to location of stereo camera 170.

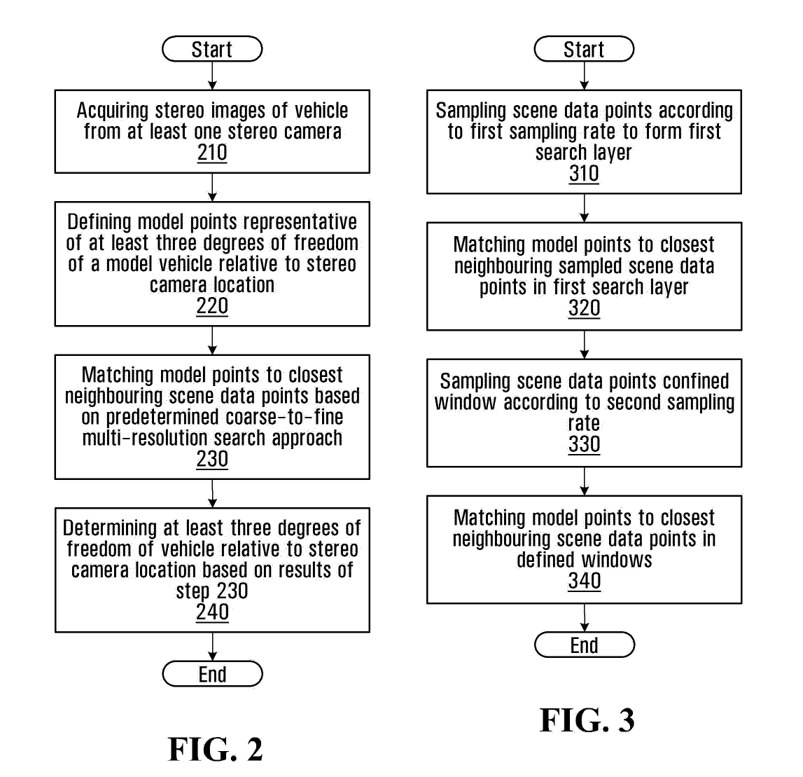

Referring to FIG. 2, a method of real-time estimation of the pose of a vehicle, e.g. a haul truck, relative to a stereo camera according to an embodiment of the invention is shown generally at 200. The method includes acquiring at least one stereo image of the haul truck from at least one stereo camera (210) mounted on the vehicle. Each stereo image is represented by a plurality of scene data points. The method further includes selecting a number of model data points that are representative of at least three degrees of freedom of a model haul truck relative to the location of the stereo camera (220). The method further includes matching each model data point to a closest neighboring scene data point based on a predetermined coarse-to-fine multi-resolution search approach (230). Based on the results of the step of matching, the method determines at least three degrees of freedom of the haul truck's pose relative to the location of the stereo camera (240). Further details of the coarse-to-fine multi-resolution search approach is explained below.

Coarse-to-Fine multi-Resolution Approach to Point Cloud Registration

The standard method for registering two point clouds with high accuracy is the iterative closest point (ICP) method, first introduced by Besl and McKay (1992), and reviewed by Rusinkiewicz and Levoy (2001). As its name suggests, ICP registers two clouds in an iterative fashion. It does so by matching points from one cloud to their closest points in the other, and minimizing an error metric based on these pairs at each iteration. The essential steps taken at each iteration are: 1. select model data points from the model point cloud, 2. match each model data point to its nearest neighbor scene data point in the scene point cloud, 3. optionally weight and/or reject data point pairs, 4. calculate an error, and 5. minimize the error. The ICP variant used in various embodiments of the invention uses a point-to-plane error metric (Chen & Medioni, 1991; Rusinkiewicz & Levoy, 2001) and a new accelerated point-matching method, i.e. a coarse-to-fine multi-resolution approac. This approach does not involve any form of tracking on the truck, and treats each frame completely independently.

The search method used by this system has proved efficient, runs in guaranteed time and requires no pre-processing. In a conventional search method, the sampling frequency is ruled by the resolution of the sensor that created the data, not by the real-world characteristics of the data itself. However, in the present invention a search strategy is adapted that considers the nature of the data, thereby eliminating the need for an exhaustive search.

Consider the structure of a stereo camera's 2.5D data. Each camera pixel (i, j) maps directly (via the lens' projection function) to a single (x, y, z) point in space. The vector connecting the (x, y, z) point in space to the (i, j) sensor pixel is the path travelled by the light ray between a surface in the world and the camera's 2D sensor. By considering the pinhole projection,

$$( \begin{matrix}u \\ v\end{matrix} ) = - \frac{f}{z} ( \begin{matrix}x \\ y\end{matrix} ) \qquad Equation 1$$

it can be seen that (x, y, z) locations that are close to each other in space will project to 2D points (i, j) that are close to each other on the sensor. (The position (u, v) in meters corresponds to the pixel position (i, j) in the image.) Likewise, so long as the imaged world is sufficiently smooth, 2D points (i, j) that are close to each other on the sensor are likely to have been projected from (x, y, z) locations that are close to each other in space. Consequently, by assuming that the 3D point (x₁, y₁, z₁) projected to pixel (i, j) is similar in location to the 3D point (x₂, y₂, z₂) projected to pixel (i±1, j±1), the (i, j) pixel location may be treated as an index from which to construct a coarse-to-fine search strategy.

To understand the coarse-to-fine search method presented here, consider a single search where one model data point is to be matched to the closest scene data point. An exhaustive search would measure the distance (defined in the Euclidian sense,

{square root over ((xₛ−xₘ)²+(yₛ−yₘ)²+(zₛ−zₘ)²))} Equation 2

from the model data point to every scene data point, storing the scene data point that produced the minimum distance. However, the coarse-to-fine multi-resolution method employs a different approach. FIG. 3 illustrates the steps of the predetermined coarse-to-fine multi-resolution search approach of FIG. 2 according to an embodiment of the invention. Referring to FIG. 3, the predetermined coarse-to-fine multi-resolution search approach includes sampling the scene data points at a first sampling rate to form a first search layer (310), such as by first sampling every 20th scene pixel (i, j) along each axis of the 2D projection. The search approach further includes matching each of the model data points to a closest neighboring one of the sampled scene data points in the first search layer (320), and storing the closest 3D point (x, y, z). A 2D projection space search window is then defined around the stored closest point, and the scene data points confined within the defined search window are sampled more finely at a second sampling rate (330). Each of the model data points is then matched to its closest neighboring sampled scene data point in the defined search window (340). This process may be repeated, producing as many search “layers” as needed, until a single pixel is reached.

Referring again to FIG. 1, to perform the predetermined coarse-to-fine multi-resolution search approach for matching of each of the model data points to its closest neighboring scene data point, computing system 180 of the system for real-time estimation of the pose a haul truck is configured to perform the functions as set forth in the steps of FIG. 3.

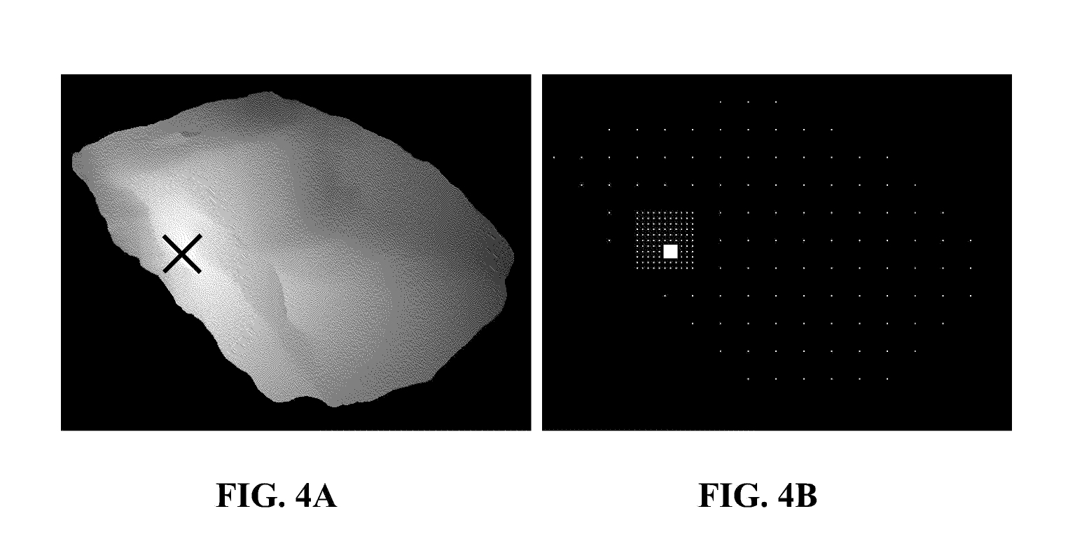

FIGS. 4A and 4B present a visual comparison between an exhaustive search (FIG. 4A) and a three-layer coarse-to-fine search (FIG. 4B), and Algorithm 2 shows a two-layer search expressed as pseudo code. FIG. 4A is a Euclidian distance map showing the distance between a single model data point (shown as a x positioned directly above the image plane) and the scene data points of a scene point cloud representing a haul truck (lighter is closer, darker is further). An exhaustive search would measure the distance between the model data point and every truck scene data point, effectively creating a distance map like this for every model data point. In the coarse-to-fine method involving three search layers, the results of which are shown in FIG. 4B, only a subset of scene data points are sampled. The different sampling rates of the three search layers of the coarse-to-fine search are clearly visible.

Algorithm 2 Find Nearest Neigbour

nearest_neighbour ← VERY_DISTANT_POINT
{Start Layer 1}
for every 8th projected point per axis do

if point is closer than nearest_neighbour then

nearest_neigbbour ← point

end if

end for
{End Layer 1}
{Start Layer 2}
for every point in a 9 × 9 window centered at nearest_neighbour do

if point is closer than nearest_neighbour then

nearest_neighbour ← point

end if

end for
{End Layer 2}
return nearest_neighbour

This strategy allows the search to proceed at low resolution speeds, while maintaining the accuracy afforded by high resolution data. From an intuitive perspective, the method works by using the first, coarsest search layer to locate the nearest “large feature” in the scene point cloud, with the subsequent search layers locating the actual closest scene data point within the large feature. It is the first search layer's sampling frequency that in essence defines how smooth the world is assumed to be. If the frequency is chosen based on the physical attributes of the scene, rather than the resolution of the camera sensor, the speed of the search may be largely decoupled from the resolution of the camera sensor.

In a preferred embodiment, the coarsest sampling rate (pixels) is chosen such that the projection onto each sensor axis of the smallest detectable feature area of the sampled object is larger than the separation between samples. Using the pinhole camera model (Equation 1), the first sampling rate may be expressed as:

$$α = \frac{r ρ cos ( 45 ° ) cos ( {θ}_{x} ) cos ( {θ}_{y} )}{2 d tan ( \frac{F O V}{2} )} \qquad Equation 3$$

where a (pixels) is the coarsest per-axis sampling rate in projection space, r (pixels) is the linear resolution of the camera, p (m) is length in the scene of the smallest detectable feature, ^{θ}x and ^{θ}y (degrees) are the maximum angles of rotation of the patch around the x and y axes relative to the camera, d (m) is the maximum distance between the patch and the camera, and FOV (degrees) is the angular field of view of the camera. The cos(45°) term ensures that the patch will be found no matter how it is rotated about the z axis. The desired level of sampling subsequent layers (second search layer) can also be determined with Equation 3 (by using smaller values for p), or by simply selecting a sampling level where all layers will visit the same number of total points.

This strategy essentially de-couples the speed of the search from the resolution of the input data, making it instead dependant on the physical properties of the object. The invention therefore eliminates the need for an exhaustive point-cloud registration approach in which each model data point is matched to every scene data point in a scene point cloud in order to find the closest scene data point while improving search speed and efficiency.

To analyze the presented method, it is assumed that all layers after the first layer sample the same number of points. The total number of points sampled: (or touched) is:

$$i {N}_{M} [ \frac{{N}_{S}}{{α}^{2}} + L {α}^{2 / L} ] . \qquad Equation 4$$

### Model Haul Truck Creation

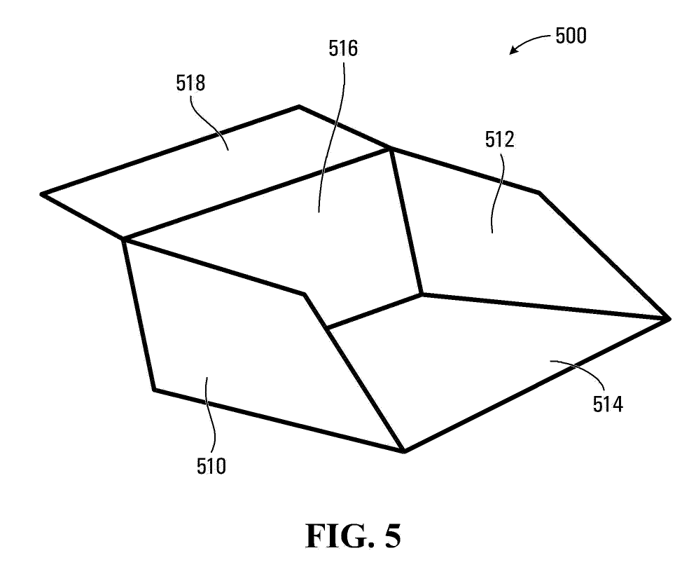

The design of the haul truck model point cloud is important for accurate registration of the model point cloud with a scene point cloud, and therefore haul truck pose estimation. Referring to FIG. 5, a simplified haul truck body is shown generally at 500. Haul truck body 500 is comprised of five planes: side wall 510, side wall 512, bottom 514, front wall 516, and protective canopy 518. During the loading process, the bottom 514, side wall 512 and front wall 516 all become obscured by the material placed into the haul truck. Therefore, they are not consistently visible features of the haul truck and cannot be relied upon for determining its pose. This leaves two planes that do remain consistently visible, i.e. the left side wall 510 and the protective canopy 518, which are used to form the model point cloud.

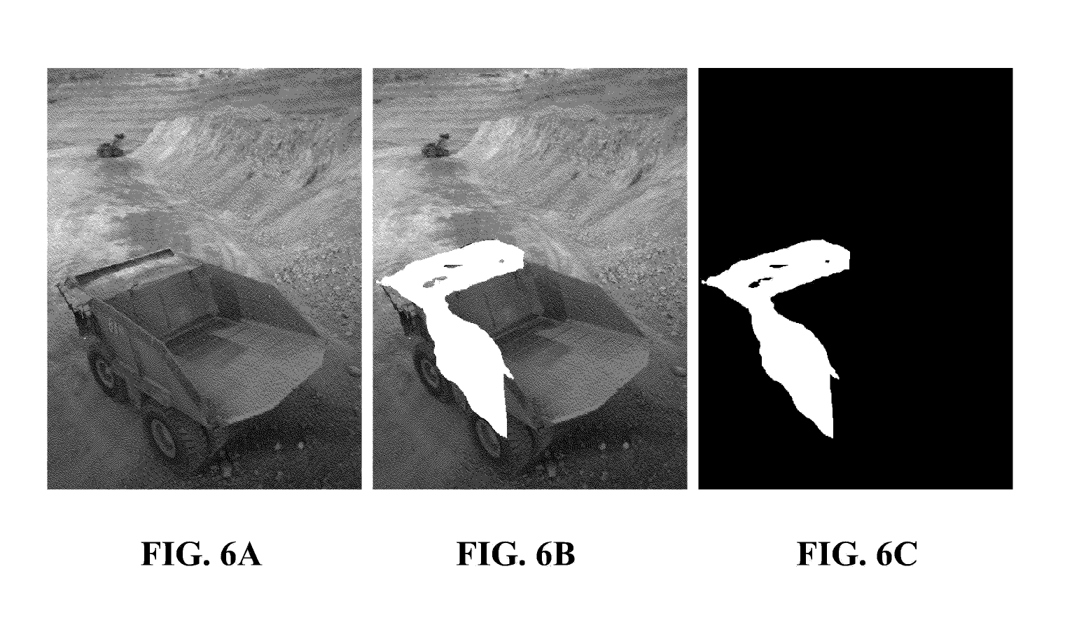

The base information used to create the model point cloud is also important. In various embodiments, a computer generated model point cloud derived from the haul truck body's design drawings may be used as it would be the most perfect copy of reality. In other embodiments, a more accurate registration may be obtained by using a model point cloud that mimics the scene point cloud as closely as possible, including the stereo camera produced distortions. Therefore, instead of using a perfect computer generated model of the haul truck, a model point cloud can alternatively be created from stereo camera data. FIGS. 6A, 6B, and 6C, illustrate the creation of a model point cloud from stereo camera data. FIG. 6A is a stereo image of a haul truck used to create a model point cloud. FIG. 6B shows the portion of the stereo image that is to be used to define the model point cloud. FIG. 6C shows the model point cloud in isolation.

In embodiments where a stereo camera sourced haul truck model point cloud is used, such as one shown in FIG. 6A to 6C, the model's initial pose (i.e. at least three degrees of freedom; e.g. six degrees of freedom) relative to the stereo camera must to be determined. One approach would be to physically measure the relative positions of the camera and the haul truck during model data acquisition using standard physical surveying techniques. According to a preferred embodiment, the initial pose is determined directly from the same data used to create the initial model point cloud. This can be done using an alternative pose estimation technique that does not depend on 3D data but rather solely a simple 2D image as delivered by one of the two stereo camera imagers. The method, known as the Perspective-n-Point, or PnP method, consists of identifying n points on an object in a 2D image and, by using knowledge of the relative 3D positions of the n points, determining where the object is in space in order to produce the observed projection.

In order to guarantee a unique pose solution using PnP, the number of identified points n must be greater than or equal to six (n≧6), or there must be at least four co-planar points of which no three are co-linear. The identification of the points in the 2D image need not be automated as this procedure is only performed once when the model point cloud is created. An iterative Gauss-Newton approach to solving the PnP problem may be used

### Haul Truck Payload Volume, Distribution and Mass

Before load profiling can be accomplished, it is essential to accurately determine the pose of the truck, for it is the truck that forms the reference frame in which the payload must be measured. This can be done as previously described. Once this reference frame has been established, profiling the load involves measuring how the observed surface of the truck's payload area differs from where the known bed of the truck lies. This information reveals the volume, the distribution, and, with payload density information, the mass of the contents of the truck.

Referring again to FIG. 1, load profiling, as with truck pose estimation, may be accomplished with the 2.5D data provided by stereo camera 170. As with the system for real-time pose-estimation of a haul truck, a system for real-time profiling of a payload in a haul truck bed also includes at least one stereo camera 170 and a computing system 180. According to the illustrated embodiment, stereo camera 170 is configured to mount on shovel 190 for acquiring stereo images of a haul truck. The stereo images are comprised of a plurality of scene data points. Computing system 180 is in electrical communication with the stereo camera 170, and is configured in the illustrated embodiment to define a number of model data points representative of at least three degrees of freedom of a model haul truck relative to the location the stereo camera, match each model data point to a closest neighboring scene data point based on a predetermined coarse-to-fine multi-resolution search approach, determine the location of the bottom of the haul truck bed (e.g. bottom 514 in FIG. 5) based on the matching of each of the model data points to its closest neighboring scene data point; determine the location of the surface of the payload; and calculate the difference between the observed height of the surface of the payload and the determined location of the bottom of the haul truck bed.

In various embodiments, the method to determine the load volume (and distribution) involves calculating the average data point height of the observed surface above the known location of the truck bottom. The payload area may also be divided into a 3×3 grid, with the volume of each element determined separately, and then the volumes of these elements summed to arrive at the total volume.

Because of the stereo camera's perspective of the truck's payload, it is sometimes not able to accurately image the entire contents. This is because parts of the payload are occluded, and the stereo processing becomes unreliable where the material creates a sharp angle against the far side wall. Accordingly, in some embodiments only the middle 90% of the contents is measured, with the unavailable data being interpolated from the observed surface.

### Bucket Fill Factor and Recommended Dump Location

In further embodiments, the system and method for real-time profiling of a payload may further include additional features to provide feedback to the operator for loading assistance, including bucket fill factor and recommended dump location.

The volume of material contained per shovel bucket load is an important measure because it is one of the prime indicators as to how efficiently the shovel is being used. By measuring the truck volume on a once-per-bucket basis, the bucket fill-factor could be relayed back to the shovel operator. This would allow the operator to objectively measure how efficiently the available bucket volume is being used. Additionally, when the operator is digging the last load to be dumped into a truck, the system could recommend a fill factor to avoid over- (or under-) loading the truck.

If a load of material is dumped in an incorrect spot, the truck will not be centre-loaded. In order to correct this, the following bucket load will have to be dumped off-centre, but on the opposite side of the truck. The present system can detect when and by how much the haul truck is from being centre loaded, and by using models of how material will slump when deposited onto a slope, the system could recommend where the following bucket be dumped in order to re-establish a centrally loaded truck.

### Equations

### Equation 3

To determine the coarsest sampling rate, the smallest feature length p must be found in units of pixels when it is projected from a distance d onto the image sensor. The camera is modeled as a pinhole camera with a linear resolution, r (pixels) and field of view, FOV (degrees) (see FIG. 12). At a distance d, the camera's linear field of view (m) is given by:

$$2 d tan ( \frac{F O V}{2} ) . \qquad Equation 5$$

If the camera has a linear resolution r, then this field of view is projected onto r pixels, where each pixel represents the same linear distance:

$$\frac{r}{2 d tan ( \frac{F O V}{2} )} . \qquad Equation 6$$

Thus, if the previous equation represents the number of pixels per linear meter at distance d, the numbers of pixels spanned by p will be

$$\frac{r p}{2 d tan ( \frac{F O V}{2} )} . \qquad Equation 7$$

However, the previous equation assumes that p is presented without any angular rotation. If p is rotated away from the camera (rotated about the x or y axis), then its projected size length will shrink by a factor of the cosine of the rotation angle. Additionally, a rotation about z changes the proportion of the feature that is projected in the combined x or y axis of the projection. As the coarsest regular sampling is to be determined, the smallest simultaneous projection in the x and y axes must be considered, which occurs when the angle of rotation about the z axis is 45. Because all of these rotations shrink the size of the projection, the final equation for a must be discounted by a factor of each:

$$α = \frac{r ρ cos ( 45 ° ) cos ( {θ}_{x} ) cos ( {θ}_{y} )}{2 d tan ( \frac{F O V}{2} )} . \qquad Equation 3$$

Equation 4

To find the closest scene point to a single model point, the number of search operations takes the form p+q, where p is the number of operations for the first search layer and q is the number of operations for subsequent layers. For an exhaustive search, p+q would equal NS, the total number of points in the scene cloud. However for the coarse-to-fine search, the total number of searches is reduce by sub-sampling. The number of search operations in the first layer is a function of NS and the sampling rate, a, determined in Equation 2. Since a is the number of points skipped along both axes, the number of points searched in the first layer is reduced by a factor of a twice, giving Any number of sampling strategies can be adopted for subsequent layers, but for the purposes of this analysis it is defined as follows:
A search window is square, and the length of the sides are equal to the pervious layer's sampling rate;
A search window is centered at the closest point found in the previous search layer;
All search layers in q sample the same number of points;
The final search layer does not sub-sample.

The number of search operations in q depends only on a, and the number of search layers it employs, L. If only a single search layer is used, then it is also the last search layer and so is sampled exhaustively, performing a² search operations. If more than one search layer is used, then as each layer must sample the same number of points, each layer must sample ^{L}\sqrt{a²} points. (This can be seen by reasoning that the length of the final search layer's window, w, when raised to the power of the number of layers, must equal a: w^{L}=a.) Since each of the L search layers searches the same number of points, and there are L layers, the total number of points search in q is

q=La^{2/L} Equation 8

and therefore

$$p + q = \frac{{N}_{S}}{{α}^{2}} + L {α}^{2 / L} \qquad Equation 9$$

Because a nearest neighbor must be found for all considered model points at each iteration, the total number of search operations is:

$$i {N}_{M} [ \frac{{N}_{S}}{{α}^{2}} + L {α}^{2 / L} ] . \qquad Equation 4$$

### EXAMPLES

The system was installed on a production P&H™ 2800 XPB electric mining shovel. The stereo camera used was a Bumblebee XB3™ camera produced by Point Grey Research Inc having a 24 cm wide baseline, 1280×960 resolution CCD sensors, and 66° horizontal field of view. Stereo image pairs were recorded at 10 Hz as the shovel loaded two haul trucks.

Because the system is required to operate in real-time, the speed at which the stereo data can be processed and the truck position determined is an important measure of performance. Implemented using a combination of C++ and (for the GUI) C# on an Intel T7700 2.4 GHz Core 2 Duo CPU with 667 MHz DDR2 SDRAM, at a resolution of 1024×768, the system performed stereo processing at 5.3 Hz, and performed both stereo processing and pose estimation at 1 Hz. This pose estimation speed was sufficiently fast for an operational loading assistance system.

The system was single threaded, and as both stereo processing and ICP point-matching can be programmed in a parallel manner, the speed of the system should scale with the number of cores used. If programmed to run on a graphics processing unit (which are massively parallel), large performance improvements could be realized.

### Pose Estimation

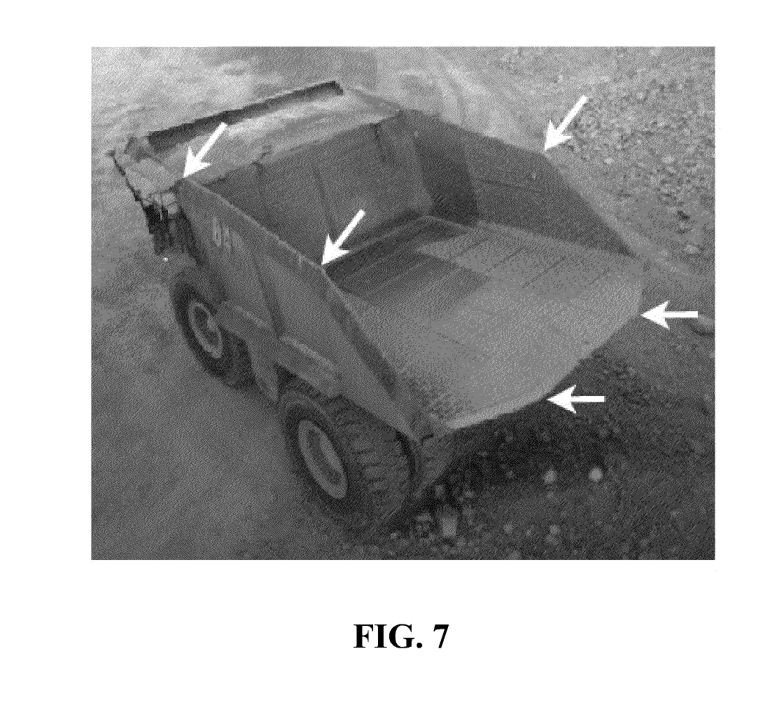

The accuracy of the PnP pose estimation system is limited by the accuracy of the localization of the known points in the image, and the accuracy of their real-world 3D relationships. Their 3D relationships were provided with millimeter accuracy by the haul truck body's manufacturer. Precisely locating the known haul truck points, shown in FIG. 7, is somewhat less precise as they are not sharp high-contrast corners and cannot be found to sub-pixel accuracy, which consequently lead to multiple but very similar solutions. Therefore, multiple solutions for the haul truck were found, with the pose containing the median rotation being selected as the best possible pose. (A median was chosen over the mean because as all parameters for a single pose are determined in conjunction with one another, it was reasoned that the integrity of a pose could be compromised by averaging multiple poses' individual components.) This method was also used to determine the ground truth to verify the pose results generated by the ICP-based method.

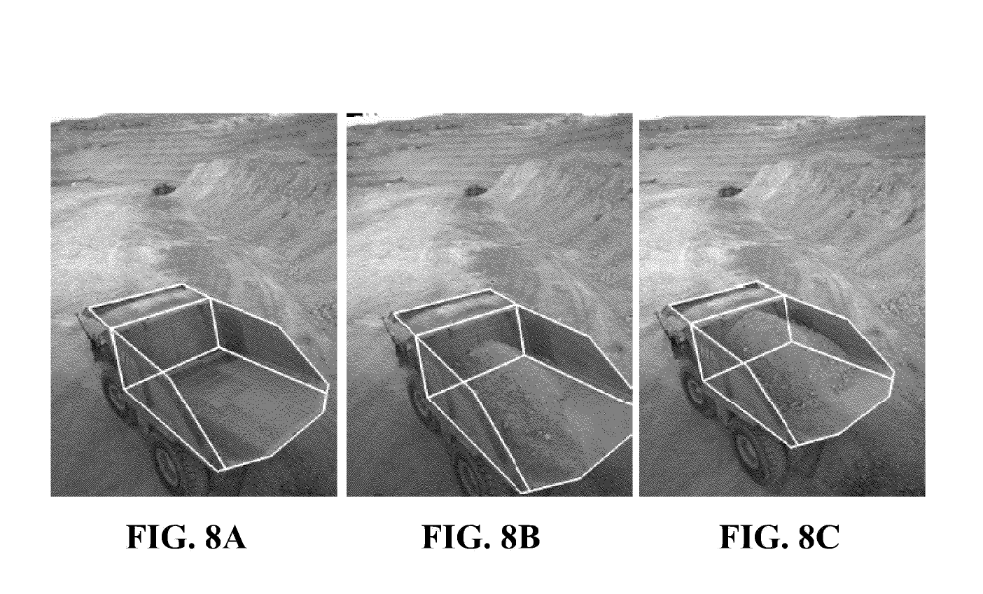

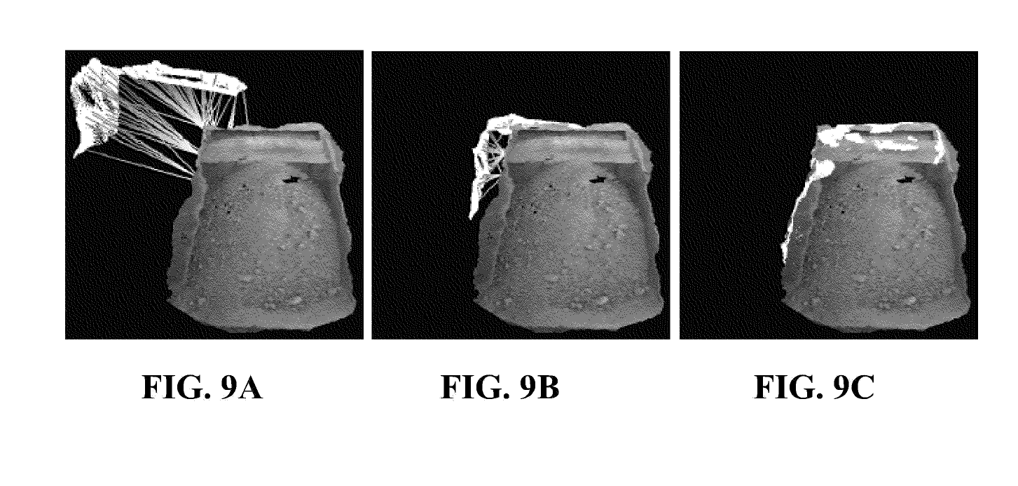

FIG. 8 shows a wireframe of the haul truck positioned on stereo images of a scene truck that is empty (FIG. 8A), partially full (FIG. 8B), and mostly full (FIG. 8C). In FIG. 9, three stages of ICP convergence of the model point cloud on the scene point cloud are shown: the initial position (FIG. 9A), the position after one iteration (FIG. 9B), and the position after convergence (FIG. 9C). Qualitatively, the initial results appear accurate. The lines connecting the model point cloud and the scene point cloud represent a few of the points matched during the nearest neighbor.

The coarse-to-fine nearest neighbor search method was evaluated by comparing it to an exhaustive nearest neighbor search at multiple sampling resolutions. The results are presented in Table 1, where the (a; b; c) triplet in column 1 represents the pixel sampling frequency on both projected axes for each successive search layer. Differences in computation time and final pose were recorded, showing that coarser sampling leads to faster performance but also an increased discrepancy in the final pose estimation. These differences in the final pose estimation are minimal, especially when considered on a percentage basis.

TABLE 1
Comparison of an exhaustive search and resolution independent nearest neighbour search method.

| | Search | Total | | Time per | Relative Time | Change in | Change in |
|---|---|---|---|---|---|---|---|
| | Operations | Time | | Iteration | Taken Per | Translation | Rotation |
| | Per Iteration | (s) | Iterations | (s) | Iteration | (m) | (°) |
| Exhaustive | 282,345,085 | 546.415 | 43 | 12.71 | 1 | -.- | -.- |
| Fast Search | 11,379,154 | 18.42 | 40 | 0.46 | 0.0362 | 0.010 | 0.10 |
| (5, 2, 1) | | | | | | | |
| Fast Search | 896,659 | 1.667 | 39 | 0.04 | 0.0034 | 0.043 | 0.17 |
| (20, 3, 1) | | | | | | | |
| Fast Search | 530,099 | 1.14 | 42 | 0.03 | 0.0021 | 0.048 | 0.06 |
| (40, 3, 1) | | | | | | | |

### Error Analysis

Stereo camera error is difficult to characterize because the error is dependent on the accuracy of the correlation used in the stereo processing, which itself is dependent on the texture and geometry of the scene being imaged. As texture and geometry are different for virtually every data point, so is the uncertainty.

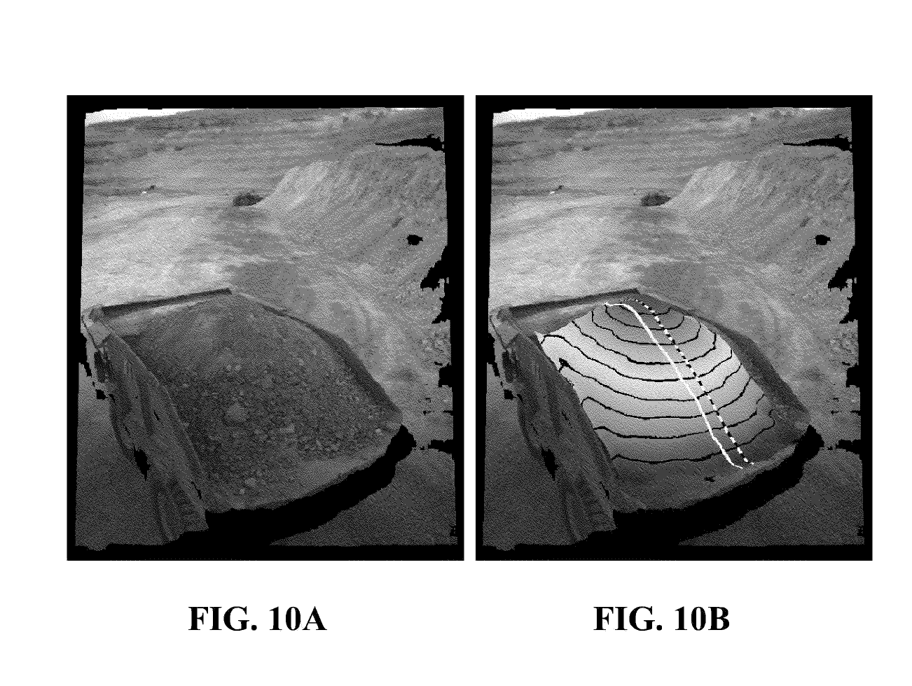

However, it is still informative to have a notion of the approximate uncertainty for a point at a given working distance. The manufacturer of the stereo camera used in this application states that the correlation is usually accurate to within 0.1 pixels (one standard deviation). The error in the z direction is determined by:

$$Δ z = \frac{{z}^{2}}{f b} ɛ \qquad Equation 4$$

where f is the focal length of the camera, b is the stereo baseline, ands is the correlation error. At distances of 12 m and 16 m, with a camera resolution of 1024×768, the uncertainties in z are ±0:076 m and ±0:135 m respectively. See FIG. 10 for a graph of depth uncertainties. The (x; y) translational uncertainty is provided by the manufacturer, is directly proportional to the depth (z) value of the data point, and is far less significant than the uncertainty in z. At distances of 12 m and 16 m, the (x; y) uncertainties are ±0:005 m and ±0:007 m respectively.

A second source of error exists in the fit provided by the image registration process. The implemented point-to-plane operates by minimizing the sum of the square of the distances between the planes defined at model data points that have been matched to scene cloud data points. The RMS error is the error in fit between the model and image clouds, which is present due to errors in the stereo camera data and in imaging the truck from different perspectives. Testing showed that the RMS error at 15 m distances typically lie between 0.05 and 0.1 m, or about 0.5% of the total distance.

The internal matching error reported by ICP is not the true error, i.e. it is a measure of how well the two point clouds have been registered, but not how well the model cloud has been matched to ground truth. Perspective-n-Point (PnP) can used to estimate the ground truth by manually identifying five known truck points in a 2D picture pose (FIG. 7). However, the known five points cannot be located at sub-pixel accuracy, which leads to a range of possible ground truths. To estimate the ground truth for a particular picture, PnP pose estimation was performed seven times, with the pose with the median rotation angle for the seven estimations being selected as ground truth. For every different picture, the standard deviation of its seven possible ground truth poses were calculated, with the mean standard deviation shown in Table 2, indicating that the differences for a single pose using seven rounds of PnP were small.

TABLE 2
Uncertainty in ground truth determination using PnP

| | PnP |
|---|---|
| Mean Standard Deviation of Translation (m) | 0.012 |
| Mean Standard Deviation of Rotation (degrees) | 0.037 |

Once ground truth was established, ICP-based pose estimation was performed, with the resultant pose compared to ground truth. Both exhaustive and fast nearest neighbor search were used for comparison purposes, with the results shown in Table 3. The fast search's (a; b; c) triplet represents the sampling frequency in pixels at the three successive search layers. It is particularly instructive to measure the error at the outermost (extreme) points of the haul truck, where a shovel-truck collision is most likely to occur. Using the fast nearest neighbour search with ICP, the mean error resulting from translation and rotation errors at the very rear of the truck's bed was 0.11 m with a standard deviation of 0.04 m. The worst case observed error was 0.16 m. This maximum error can be used to define an exclusion zone for the shovel bucket control system.

TABLE 3
Error in ICP pose estimation

| | | Fast Search |
|---|---|---|
| | Exhaustive | (12, 3, 1) |
| Mean Translation Error (m) | 0.062 | 0.072 |
| Std. Dev. of Translation Error (m) | 0.013 | 0.021 |
| Maximum Translation Error (m) | 0.079 | 0.090 |
| Mean Rotation Error (degrees) | 0.27 | 0.27 |
| Std. Dev. of Rotation Error (degrees) | 0.24 | 0.18 |
| Maximum Rotation Error (degrees) | 0.58 | 0.51 |

### Load Profiling

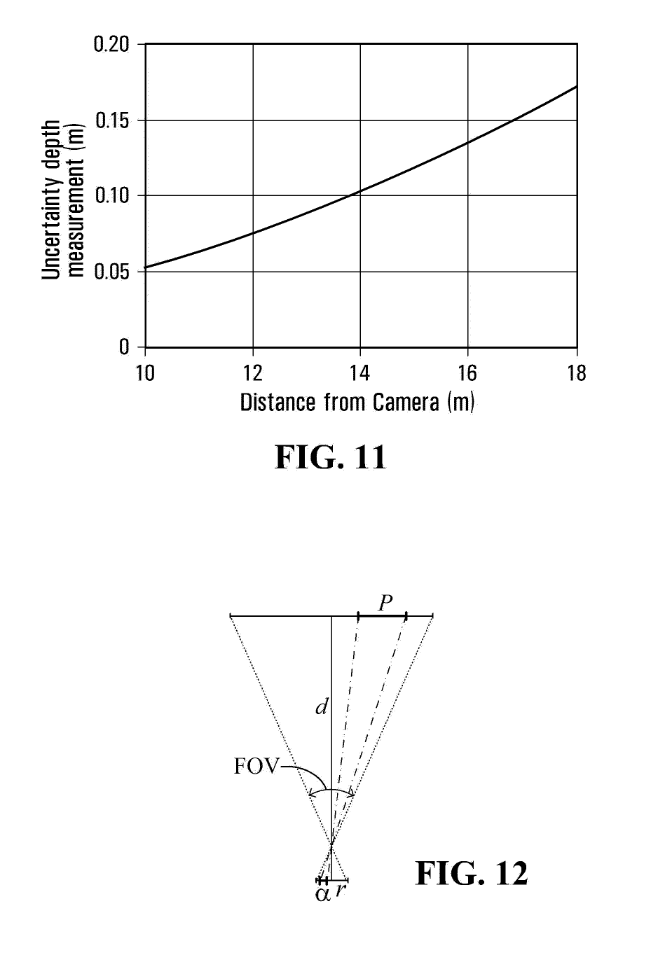

Load profiling was performed following haul truck pose estimation. As shown in FIG. 11B, the results of the payload profiling are not entirely numerical as the analysis is also presented in a form which is easily used by the shovel operator to improve the quality of the loading, and aid in delivering the best possible payload profile. A color-height encoded relief surface with contour lines may also be created for display purposes.

The load profiled in FIGS. 11A and 11B was measured to have a volume of 108 cubic meters, and a centre of mass (dotted line) that is 0.47 meters off centre (white line). The contour lines represent even elevation gains, the white line represents the ideal centre of mass, and the dotted line represents the current centre of mass. Additionally, the ideal centre of mass and the current centre of mass of the truck is shown, so that they may be compared to improve the loading process.

Volume estimation was performed by measuring the payload's surface, and calculating how far above the known location of the truck's bottom that it lies. Conceptually, the method to determine the load volume (and distribution) is to simply calculate the average data point height of the observed surface above the known location of the truck bottom. However the process is complicated somewhat by the effects of projection and perspective foreshortening, effects which result in surfaces that are closer to the camera or orthogonal to its direction of view having a disproportionate number of data points compared to surfaces that are further away or presented at an angle. For this reason, in this example, the payload area was divided into a 3 by 3 grid, with the volume of each element determined separately, and then the volumes of these elements summed to arrive at the total volume. As the surface of the material in the truck is mostly smooth, the effects of projection-derived data and perspective foreshortening were be effectively eliminated.

Due to stereo camera's perspective of the truck's payload, it is not able to accurately image the entire contents because parts of the payload are occluded. Moreover, the stereo processing becomes unreliable where the material creates a sharp angle against the far side wall. For this reason, only the middle 90% of the contents was measured, with the unavailable data being interpolated from the observed surface.

The absolute accuracy of profiling the load is difficult to assess. However, it is possible to determine the expected accuracy of the system by considering the errors found in truck pose estimation. Volume estimation was performed by measuring the payload's surface, and calculating how far above the known location of the truck's bottom that it lies. Error in the measurement of the surface itself results from errors in the stereo camera data points, and as there are many points and the error is Gaussianly distributed, error in the measurement of the surface should not be significant. However, the position of the bottom of the truck is determined by the truck pose estimation, so an error in pose estimation will lead directly to an error in volume estimation. As shown in Table 3, the mean truck translation error was 0.072 m, and the mean error in rotation was 0.27 degrees. To assess how this affects the volume results, an experiment was conducted where the haul truck pose, as found by ICP, was displaced in a random direction by the mean errors in translation and rotation, and the volume of the truck was re-calculated. This process was repeated 100 times per base volume, and the results are shown below in Table 4. For each base volume, the mean absolute error was less than 0.1 m³.

TABLE 4
The observed change in calculated payload volume by moving
the truck's position by the mean error, 100 times per base volume.

| | Standard | | Absolute |
|---|---|---|---|
| | Deviation of | Standard Deviation | Maximum |
| Base Volume | Volume Errors After | of Volume Errors as | Error |
| (m³) | Displacement (m³) | a % of Total Volume | (m³) |
| 32.8 | 1.3 | 4.0 | 2.6 |
| 60.3 | 1.4 | 2.3 | 2.5 |
| 108.0 | 1.5 | 1.4 | 2.8 |

While specific embodiments of the invention have been described and illustrated, such embodiments should be considered illustrative of the invention only and not as limiting the invention as construed in accordance with the accompanying claims.

### REFERENCES

Duff, E. (2006). Tracking a vehicle from a rotating platform with a scanning range laser. In Proceedings of the Australian Conference on Robotics and Automation.
Green, M. E., Williams, I. A., and McAree, P. R. (2007). A framework for relative equipment localisation. In Proceedings of the 2007 Australian Mining Technology Conference, pages 317{331, The Vines, WA, Australia.
Joseph, T. G. and Welz, M. (2003). Mechanical action and geophysical reaction: Equipment oil sand interactions. In Proceedings of CIM Coal and Soft Rock Workshop, Saskatoon, SK.
Mechefske, C. and Campbell, C. (2007). Estimating haul truck dutymeters using operational data. In CIM Bulletin, volume 2.
Stentz, A., Bares, J., Singh, S., and Rowe, P. (1999). A robotic excavator for autonomous truck loading. Autonomous Robots, 7(2):175-186.

What is claimed is:

1. A method of estimating the pose of a vehicle relative to a stereo camera, the method comprising:
acquiring at least one stereo image of the vehicle from the stereo camera, wherein the stereo image comprises a plurality of scene data points;
selecting a plurality of model data points corresponding to a model of the vehicle, wherein the plurality of model data points is representative of at least three degrees of freedom defining the pose of the model relative to the stereo camera;
matching each of the plurality of model data points to a closest neighboring one of the plurality of scene data points according to a predetermined coarse-to-fine multi-resolution search approach; and
based on the results of the matching, determining at least three degrees of freedom defining the pose of the vehicle relative to the stereo camera.

2. The method of claim 1, wherein the predetermined coarse-to-fine multi-resolution search approach comprises the steps of:
(a) sampling the plurality of scene data points at a first sampling rate to generate a first search layer of sampled scene data points;
(b) matching each of the plurality of model points to a closest neighboring one of the sampled scene data points in the first search layer;
(c) sampling a subset of the scene data points confined within a defined window around each of the closest neighboring ones of the sampled scene data points identified in step (b) at a second sampling rate; and
(d) matching each of the plurality of model points to a closest neighboring one of the sampled subset of scene data points within the defined window.

3. The method of claim 2, wherein each of the at least one stereo images is a 2D projection of a 3D environment in which the vehicle is located, wherein the first sampling rate is determined by the formula:
$$∝ = \frac{r ρ cos ( 45 ° ) cos ( θ x ) cos ( θ y )}{2 d tan ( \frac{F O V}{2} )}$$
wherein a is the sampling rate in the 2D projection space in pixels, r is the linear resolution in pixels of the camera, p is length of the smallest detectable feature in metres in the image, ^{θ}x and ^{θ}y are the maximum angles in degrees of rotation of the patch around the x and y axes relative to the camera, d is the maximum distance in metres between the patch and the camera, and FOV is the angular field of view in degrees of the camera.

4. The method of claim 3, wherein the second sampling rate is determined by the same equation as the first sampling rate.

5. The method of claim 2, wherein the second sampling rate is lower than the first sampling rate.

6. A system for determining the pose of a vehicle relative to a stereo camera, the system comprising:
a stereo camera for acquiring at least one stereo image of the vehicle, wherein the stereo images comprise a plurality of scene data points; and
a computing system in communication with the at least one stereo camera, the computing system being configured to:
receive the plurality of scene data points from the at least on stereo camera,
select a plurality of model data points corresponding to a model of the vehicle, wherein the plurality of model data points representative of at least three degrees of freedom defining the pose of the model relative to the stereo camera;
match each of the plurality of model data points to a closest neighboring one of the scene data points based on a predetermined coarse-to-fine multi-resolution search approach; and
based on the results of the match, determine at least three degrees of freedom defining the pose of the vehicle relative to the stereo camera.

7. The system of claim 6, wherein the stereo camera is configured to mount on a boom of a shovel mounted on the vehicle.

8. The system of claim 6, wherein the computing system is housed inside a housing of a shovel mounted on the vehicle.

9. The system of claim 6, wherein to match each of the plurality of model points to the closest neighboring one of the scene data points based on the predetermined coarse-to-fine multi-resolution search approach, the computing system is configured to:
(a) sample the scene data points according to a first sampling rate to generate a first search layer of sampled scene data points;
(b) match each of the selected model data points to a closest neighboring one of the sampled scene data points in the first search layer;
(c) sample a subset of the scene data points confined within a defined window around each of the closest neighboring one of the sampled scene data points identified in step (b) at a second sampling rate; and
(d) match each of the plurality of model points to a closest neighboring one of the sampled subset of scene data points within the defined window.

10. The system of claim 9, wherein each of the at least one stereo images is a 2D projection of a 3D environment in which the vehicle is located, and wherein the first sampling rate is determined by the formula:
$$∝ = \frac{r ρ cos ( 45 ° ) cos ( θ x ) cos ( θ y )}{2 d tan ( \frac{F O V}{2} )}$$
wherein a is the sampling rate in the 2D projection space in pixels, r is the linear resolution in pixels of the camera, p is length of the smallest detectable feature in metres in the image, ^{θ}x and ^{θ}y are the maximum angles in degrees of rotation of the patch around the x and y axes relative to the camera, d is the maximum distance in metres between the patch and the camera, and FOV is the angular field of view in degrees of the camera.

11. The system of claim 10, wherein the second sampling rate is determined by the same equation as the first sampling rate.

12. The system of claim 9, wherein the second sampling rate is lower than the first sampling rate.

13. A method of profiling a payload in a vehicle bed of a vehicle, the method comprising:
acquiring at least one stereo image of the vehicle bed containing the payload from a stereo camera located at a fixed position relative to the vehicle bed, wherein the stereo image comprises a plurality of scene data points;
selecting a plurality of model points corresponding to a model of the vehicle bed, wherein the plurality of model points is representative of at least three degrees of freedom defining the pose of the model relative to stereo camera;
matching each of the plurality of model data points to a closest neighboring one of the scene data points according to a predetermined coarse-to-fine multi-resolution search approach; and,
based on the results of the matching,
determining the position of the payload surface within the vehicle bed;
determining the position of a vehicle bed bottom within the vehicle bed; and
calculating the difference between the position of the payload surface and the position of the vehicle bed bottom.

14. The method of claim 13, wherein the predetermined coarse-to-fine multi-resolution search approach comprises the steps of:
(a) sampling the scene data points at a first sampling rate to generate a first search layer of sampled scene data points;
(b) matching each of the plurality of model points to a closest neighboring one of the sampled scene data points in the first search layer;
(c) sampling a subset of the scene data points confined within a defined window around each of the closest neighboring one of the sampled scene data points identified in step (b) at a second sampling rate; and
(d) matching each of the plurality of model points to a closest neighboring one of the sampled subset of scene data points within the defined window.

15. The method of claim 14, wherein each of the at least one stereo images is a 2D projection of a 3D environment in which the vehicle is located, and wherein the first sampling rate is determined by the formula:
$$∝ = \frac{r ρ cos ( 45 ° ) cos ( θ x ) cos ( θ y )}{2 d tan ( \frac{F O V}{2} )}$$
wherein a is the sampling rate in the 2D projection space in pixels, r is the linear resolution in pixels of the camera, p is length of the smallest detectable feature in metres in the image, ^{θ}x and ^{θ}y are the maximum angles in degrees of rotation of the patch around the x and y axes relative to the camera, d is the maximum distance in metres between the patch and the camera, and FOV is the angular field of view in degrees of the camera.

16. The method of claim 13 further comprising calculating a volume of the payload based on the calculated difference between the position of the payload surface and the position of the vehicle bed bottom.

17. The method of claim 15 further comprising calculating a mass of the payload based on the calculated volume of the payload.

18. The method of claim 13 further comprising calculating a center of mass of the payload based on the calculated difference between the position of the payload surface and the position of the vehicle bed bottom.

19. The method of claim 13, further comprising calculating distribution characteristics of the payload based on the calculated difference between the position of the payload surface and the position of the vehicle bed bottom.

20. The method of claim 13 further comprising displaying a relief map of the payload based on the calculated difference between the position of the payload surface and the position of the vehicle bed bottom.
